(19) United States
(12) Patent Application Publication
(10) Pub. No.: US 2012/0330935 A1
(43) Pub. Date: Dec. 27, 2012

(54) USER-SPECIFIC PRESENTATION OF TRAVEL DATA

(76) Inventor: Edward Huang, San Jose, CA (US)

(21) Appl. No.: 13/166,097

(22) Filed: Jun. 22, 2011

(51) Int. Cl. G06F 17/30

(52) U.S. Cl. 707/723; 707/E17.014

(57) ABSTRACT

Systems and methods for mediation of content-related services are provided. Information about a user may be stored in memory. Such information may be used to identify availability of the user to travel on certain days. A search is formulated based on the identified availability of the user. Each search result is evaluated to derive a user-specific value. The search results are thereafter ranked based on the user-specific value calculated. A user-specific display of travel data is then generated for presentation to the user.

### BACKGROUND OF THE INVENTION

1. Field of the Invention

The present invention generally relates to travel. More specifically, the present invention relates to the user-specific presentation of travel data.

2. Background of the Related Art

Presently available methods of providing a user with travel data requires the user to select a search engine, enter search parameters, and evaluate each result. Each of these steps is associated with various inefficiencies. For example, there are presently numerous search engines available, each of which may pertain to different aspects of travel (e.g., airfare, hotel, car rental, activities). Moreover, the choices available may differ from search engine to search engine. Some airlines, for example, only publish airfares through a search engine on a proprietary website, thereby making those fares unavailable for searching on aggregated sites.

Likewise, if a user were to comparison shop across several search engines, such a user may be forced to enter the same search parameters over and over. Such duplication of efforts may increase exponentially if the user were to adjust search parameters to accommodate flexible preferences and/or change in circumstances. Further complicating such comparison is the fact that the choices available may change from day to day, such that conducting the exact same search (e.g., same search engine, same search parameters) on different days may yield entirely different results. As such, the user must constantly refresh the search in order to have the most current and accurate data reflecting the choices available.

Moreover, there are various aspects of travel that are very user-specific. For example, a particular user may have definite preferences as to whether he/she is willing to accept one or more layovers, what star rating hotel he/she is willing to accept, location of hotel, distance from city center, etc. Further, each preference may change based on the associated price adjustment. For example, a user may dislike layovers, but if the price difference is substantial (e.g., $500 more expensive to book direct flight), the user may accept a layover. There is presently no way to gauge for such preferences, and the user is thereby forced to review each individual choice, the associated layovers (or lack of), and associated price adjustment.

There is therefore a need for improved systems and methods for user-specific presentation of travel data.

### SUMMARY OF THE INVENTION

Embodiments of the invention provide for user-specific presentation of travel data. Information about a user may be stored in memory. Such information may be used to identify availability of the user to travel on certain days. A search is formulated based on the identified availability of the user. Each search result is evaluated to derive a user-specific value. The search results are thereafter ranked based on the user-specific value calculated. A user-specific display of travel data is then generated for presentation to the user.

Various embodiments of the present invention may include methods for user-specific presentation of travel data. Such methods may include storing information in memory regarding a calendar and a travel specification associated with the user, executing instructions in order to identify that one or more consecutive calendar days available for travel, search a travel database to retrieve a plurality of results available on the identified days, calculate a user-specific value for each result based on the travel specification associated with the user, rank the plurality of results based on the user-specific values, and generate a display of information related to the highest-ranked result. The user-specific value may be calculated based on an algorithm that may be adjusted based on information expressed by or otherwise learned from the user. In some embodiments, a highest-ranked result for multiple destinations may be provided to the user.

Further embodiments may include systems for user-specific presentation of travel data. Such systems may include a memory for storing information regarding a calendar and a travel specification associated with a user and a processor for executing instructions in order to identify that one or more consecutive calendar days were available for travel, search a travel database to retrieve a plurality of results available on the identified days, calculate a user-specific value for each result based on the travel specification associated with the user, rank the plurality of results based on the user-specific values, and generate a display of information related to the highest-ranked result. Some systems may further include an interface for uploading a calendar associated with the user.

In yet another embodiment of the present invention, computer-readable storage media is provided. Embodied on such computer-readable storage media may be a program that is executable by a processor to perform a method for user-specific presentation of travel data.

### BRIEF DESCRIPTION OF THE DRAWINGS

FIG. 1 illustrates a network environment in which a system or method for user-specific presentation of travel data may be implemented.

FIG. 2 is an exemplary screenshot of user-specific presentation of travel data.

FIG. 3 illustrates a method for user-specific presentation of travel data.

### DETAILED DESCRIPTION

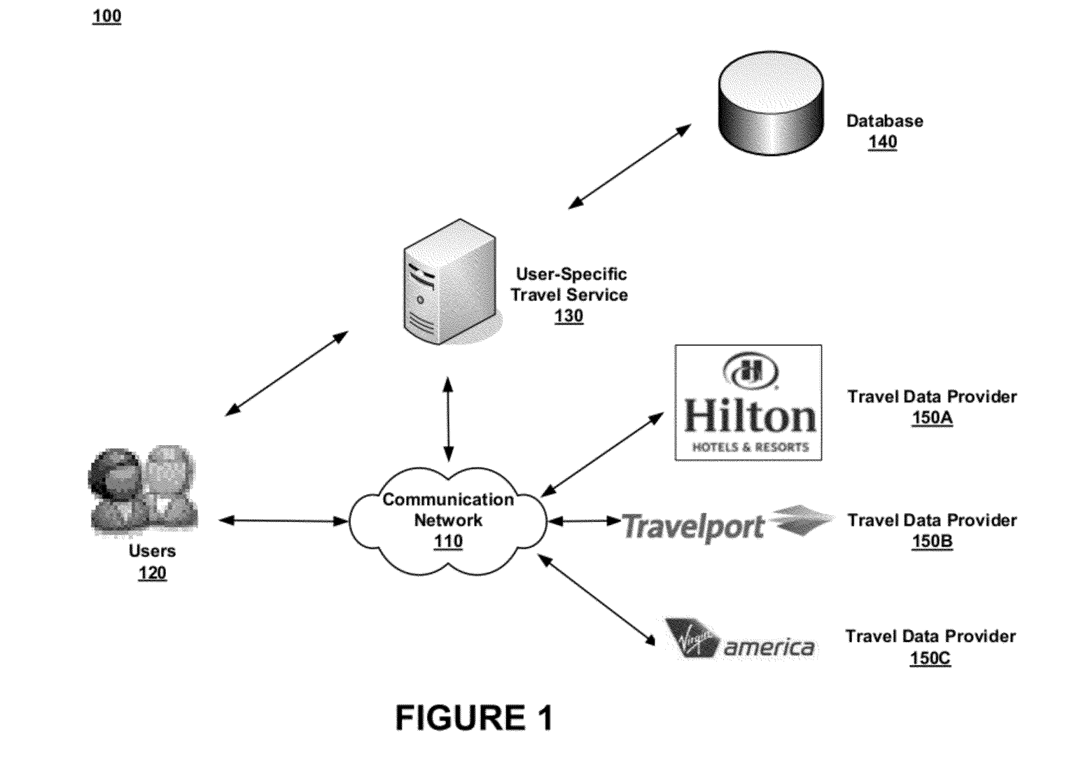

FIG. 1 illustrates a network environment 100 in which a system or method for user-specific presentation of travel data may be implemented. In network environment 100, one or more users 120 are in communication with a user-specific travel service 130, whether directly or through a communication network 110. User-specific travel service 130 may also be in communication with a database 140. The environment 100 of FIG. 1 further includes a plurality of travel data providers 150A-150C, which may communicate with users 120 and/or user-specific travel service 130 through communication network 110.

Communication network 110 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of environment 100.

Users 120 may use any number of different electronic devices such as mobile phones, smartphones, personal digital assistants (PDAs), portable computing devices (e.g., laptop, netbook, tablets), desktop computing devices, or any other type of computing device capable of communicating over communication network 110. Users 120 can access travel data directly as aggregated and published within any of the travel data providers 150A-150C.

Alternatively, users 120 may avail themselves of user-specific travel service 130 in order to filter, prioritize, and receive the information best suited to their particular situation. FIG. 1 illustrates user-specific travel service 130 as a separate component of network environment 100. In some embodiments, however, user-specific travel service 130 may be implemented as plug-in or other application installed on a device associated with the user 120 or in a network associated with the user 120.

In an exemplary use, users 120 would sign up for user-specific travel services 130 and provide calendar information, which may be done in various ways. For example, user 120 may upload or otherwise indicate a calendar (e.g., a web-based calendar such as Google®). Alternatively, the user 120 may indicate certain periods of availability for travel. For example, a user 120 may have indicated that his/her calendar has a two week window of availability for travel. User-specific travel service 130 will identify different periods of consecutive days and perform a search (e.g., on either database 140 or travel data providers 150A-150C) for each period of time. For example, for a window of June 7-21, the identified periods of time may include June 7-10, June 7-11, June 7-12, June 8-15, June 12-20, etc.

In some cases, the user 120 may additionally designate or user-specific travel service 130 may otherwise learn about a preference (e.g., for a minimum or maximum number of days) the user 120 wishes to be travelling. In some embodiments, some default travel preferences may be provided, and such defaults may be adjusted based on information regarding activity by the user 120. User-specific travel service 130 may consider such preferences and adjust the weight of each as appropriate for each user 120. The preferences may be explicitly expressed by user 120 (e.g., filling out questionnaire, checklists), or such preferences may be learned based on observing the behavior and habits of user 120 (e.g., from booked trips). For example, user 120 may book multiple trips using user-specific travel service 130. By storing information regarding such trips and analyzing the same, user-specific travel service 130 may be able to determine that the user 120 has a habit of booking travel in the summer months to family-friendly destinations near a beach.

User-specific travel service 130 may access travel data through a database 140, which may be a proprietary database, a limited-access database, a web-based database, a public database, or any combination of the foregoing. For example, database 140 may concern a particular airline or a particular hotel chain. Generally, database 140 may include any type of database and memory known in the art for storing and retrieving data related to travel, including data regarding airlines, flights, prices, hotels, amenities, etc. While

FIG. 1 illustrates database 140 as a separate component of network environment 100 in direct communication with user-specific travel service 130, database 140 may be implemented as an integrated database stored at the same location as user-specific travel service 130 or a third-party database communicating with user-specific travel service 130 over communication network 110.

In addition to database 140, user-specific travel service 130 may also consult travel data providers 150A-150C for raw data concerning travel. As discussed the background section, there are various inefficiencies involved in using such travel data providers 150A-150C. While some travel data providers 150A-150C may have some filtering options (e.g., rank by price) or allow a user to indicate certain preferences (e.g., frequent destinations), the user 120 must nevertheless conduct multiple searches and/or review many search results to find one that is best tailored to his/her preferences. There is, further, presently no way for user 120 to express preferences in terms of user-specific value. For example, user 120 may be willing to accept a certain increase in cost if it is accompanied by certain desired features (e.g., higher star rating, proximity to a beach or other desirable location, first class seats).

User-specific travel service 130 is further able to determine the value of each search result to the particular user. For each user 120, user-specific travel service 130 may store a particular algorithm for calculating a user-specific value, which represents a likely value a particular travel package would represent to the particular user. A default algorithm may be used when the user 120 initially signs up to use user-specific travel service 130, but with additional information and time, the algorithm may be continually updated to reflect the most current information related to the particular user 120. The algorithm incorporates various factors, which may include preferred departure time, whether there is a connecting flight, and other preferences related to travel. The weight assigned to each preference may be adjusted as additional information is received. User-specific travel service 130 uses such an algorithm to calculate a user-specific value for each travel package (e.g., flight, hotel, flight and hotel, etc.). Once each travel package has been assigned a user-specific value, the travel packages are ranked based on the assigned value. The highest-ranked result or highest set of results may then be displayed to the user.

Such a display of travel data may appear in various contexts. One possible context is when the user signs up and requests that travel data specific to the user be displayed. Alternatively, the search may be automatically performed (and periodically updated) for every available window in a designated calendar, and a note regarding such travel information may be automatically inserted into the user's calendar. As such, the user 120 has only to look at his/her calendar to see that he/she is available to travel during a particular period and what the best travel packages for that period of time would entail. In such a scenario, such a user 120 of user-specific travel service 130 no longer even has to request or initiate the search. In some embodiments, one-click buying of travel packages may be available, using such systems and methods as presently known in the art for billing, managing credit card information, secured transactions, etc.

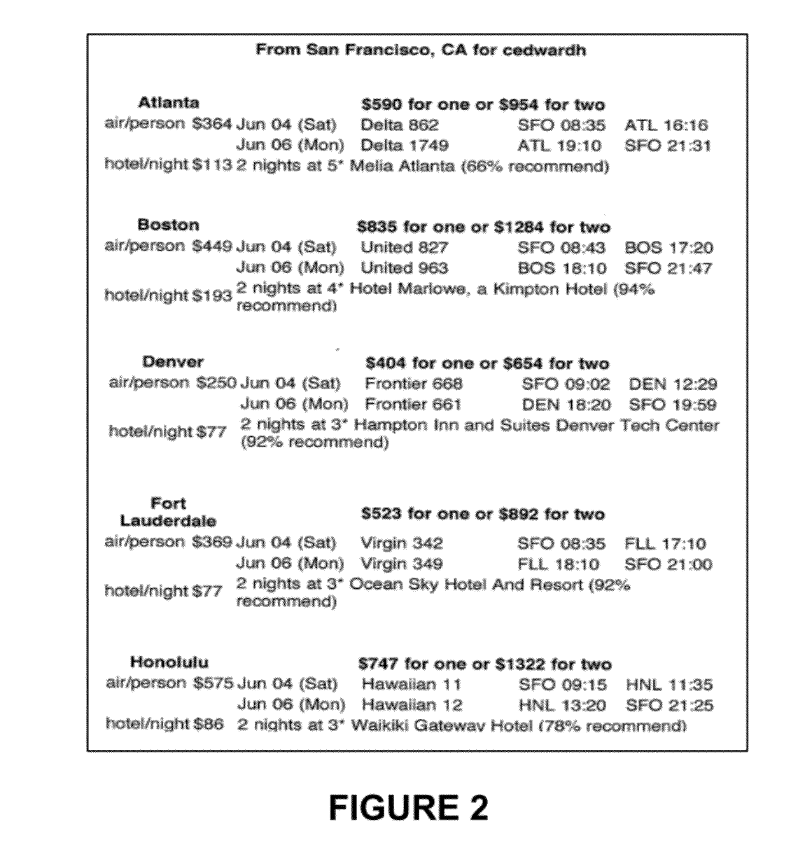

FIG. 2 is an exemplary screenshot of user-specific presentation of travel data. The illustrated presentation of travel data is based on a weekend identified in a calendar of the user as being available for travel. As illustrated in FIG. 2, information regarding multiple destinations may be presented. Such destinations may include default destinations, most popular destinations, recommended destinations, or destinations selected based on preferences expressed or learned from the user.

Not only are there multiple destinations presented, the particular entry for each destination has been determined to provide the best value according to travel specifications stored for the user 120. For example, the list of destinations in FIG. 2 includes Atlanta. To arrive at the particular travel package presented for Atlanta, multiple searches may be performed on flights originating from a home location associated with the user (e.g., SFO airport in the San Francisco Bay Area) to Atlanta on various sets of consecutive days in the two week window of availability (e.g., June 4-10, June 6-12, June 8-14). Each airfare may then be evaluated to derive a user-specific value. The airfares may then be ranked based on the calculated user-specific values. Similar searches may be performed for lodging. The travel package selected for presentation in FIG. 2 may be the highest-ranked combination of airfare and lodging in terms of user-specific value. In some embodiments, the travel package may further include such things as car rentals, activities, etc.

As a result, the travel package presented to the user 120 for Atlanta has been determined to provide the most value based on user-specific factors. The travel packages for the other destinations are determined in a similar manner. As such, the user 120 merely has to select a travel package (e.g., a destination) from among those presented. Such presentation avoids the time and energy spent in searching, entering search parameters, and evaluating various combinations of travel options to find the one best suited to the user's particular budget, needs, and preferences. The user 120 may simply review the travel package for each destination determined to be best suited to the user 120.

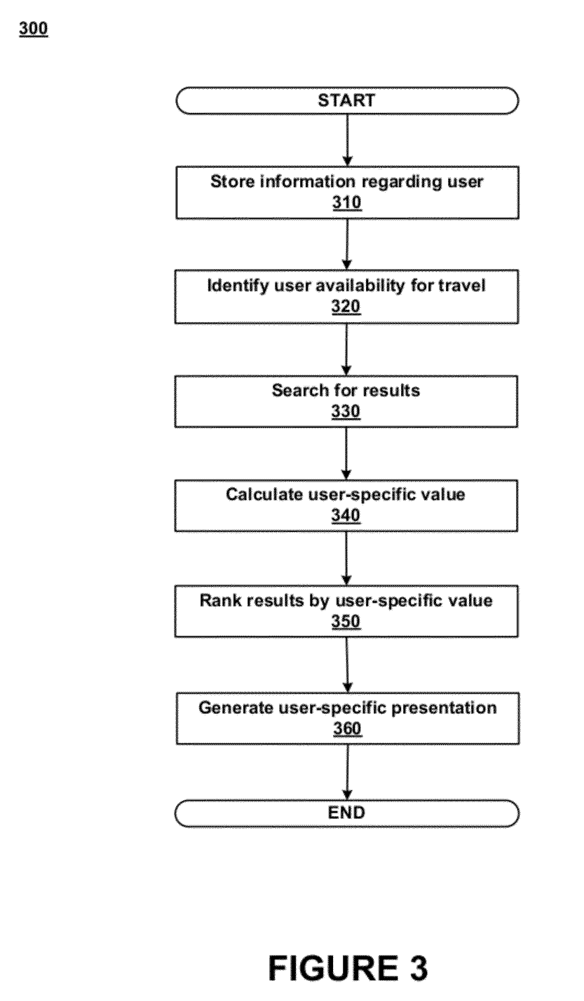

FIG. 3 illustrates a method 300 for user-specific presentation of travel data. In this method, information regarding a calendar and a travel specification is stored regarding the user, user availability for travel is identified, search results for each period of availability is obtained, user-specific values are calculated, the search results ranked by user-specific value, and the highest-ranked result(s) may be presented.

In step 310, information regarding a calendar and a travel specification is stored in memory. Such information may be provided in various ways, including information entered, sent, uploaded, and/or otherwise linked by the user 120. In some embodiments, the user 120 may be identified as already being associated with certain information (e.g., a Google® or Facebook® log-in), and such information may be automatically provided to user-specific travel service 130. For example, a user 120 upload or link to a Google® calendar, Microsoft ® Outlook calendar, or Mac OS X iCal calendar. As discussed previously, the travel specification may encompass a variety of user preferences, which may encompass default options, be provided by the user 120, and/or learned from user behavior. Such specifications may further accumulate, become more specific, and/or otherwise change over time to reflect the most current information available from the user 120. As such, the algorithm associated with the user 120 may be adjusted based on the updated specifications to provide a more accurate calculation as to likely value to that particular user 120.

In step 320, one or more periods of time may be identified as being available for user travel. Based on the calendar information stored in step 310, user-specific travel service 130 may identify various series of consecutive days in which the user 120 may be available to travel. For example, user-specific travel service 130 may identify a holiday weekend (e.g., Friday, July 1—Monday, July 4) during which the calendar indicates no plans. The calendar information may also indicate that user 120 has no plans on the days before and/or after the weekend. As such, various periods of time may be identified as being available (e.g., June 29-July 4, June 30-July 4, June 30-July 5, July 1-4, July 1-5) for travel. Such identified time periods may then be used as parameters for a search in step 330.

In step 330, search results are obtained for each of the identified periods of time identified in step 320. The search may occur with respect to a designated or associated database (e.g., database 140) or travel data provider 150A-150C. User-specific travel service 130 may, for example, search for information regarding travel to multiple destinations for each of the identified time periods. The destinations may be selected by user-specific travel service 130 based on various factors, including user request, learned user preference, default options, most popular destinations, most unusual destinations, etc. If a user 120 has demonstrated a consistent preference for sunny destinations, for example, user-specific travel service 130 may search for airfares and lodging in a variety of beach cities, such as Honolulu, Miami, and San Diego. Each period of time identified in step 320 may be searched with respect to each destination.

In step 340, a user-specific value is calculated for each search result found in step 330. As noted previously, the user 120 is associated with a user-specific algorithm for determining value for that particular user 120. While a new user 120 may be assigned a default algorithm, any information provided or learned regarding user preferences may be used to adjust the algorithm over time, such that the algorithm can accurately reflect or predict likely value to the user 120. The algorithm may consider any factors related to travel that may be important to the user 120, and as such, may incorporate different factors from one user to another. For example, one particular user may not accept layovers under any circumstances, while another user is completely agnostic as to whether there are layovers.

Yet another user may dislike layovers, but will accept a layover if it means at least $300 in price reduction. Another user may further only accept layovers if he/she can also fly business class. As noted above, such preferences may be based on observations as to what the user may find acceptable (e.g., past booked trips), or the user may explicitly express such preferences to user-specific travel service 130.

In step 350, the search results are ranked by the user-specific values calculated in step 340. Where there are multiple destinations, the search results may be separated by destination, so that a highest-ranked result for each destination may be identified. The highest-ranked travel package may not necessarily be the least expensive or more expensive, or the highest rated or the lowest rated result. Instead, the highest ranked travel package is the one determined to provide the most value to the user (e.g., the most “bang for the buck”). By calculating value using a user-specific algorithm, value (e.g., “bang”) may be defined and customized to the user's particular budget, needs, and preferences.

In step 360, a user-specific presentation may be generated for display. The display may be presented automatically, upon user request, or upon some other prompt. For example, a notification may be inserted into the calendar associated with the user. Such a notification may indicate that travel data is available on a particular date or set of dates. Upon selection by the user 120, a display may be generated in which the travel packages ranked the highest in step 350 are listed. The user 120 may further be able to select and buy the travel package directly from the display (e.g., one-click purchase). Alternatively, selection may link the user to a webpage where the user may complete the transaction. Information regarding any completed transactions may be stored and used to further refine the algorithm associated with the user.

The present invention may be implemented in an application that may be operable using a variety of end user devices. The present methodologies described herein are fully intended to be operable on a variety of devices. The present invention may also be implemented with cross-title neutrality wherein an embodiment of the present system may be utilized across a variety of titles from various publishers.

Computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for user-specific presentation of travel data, the method comprising
storing information in memory, the information regarding a calendar and a travel specification associated with the user; and
executing instructions stored in memory, wherein execution of the instructions by a processor:
identifies that one or more consecutive days on the calendar associated with the user are available for travel,
searches a travel database to retrieve a plurality of results available on the identified days,
calculates a user-specific value for each result, the user-specific value being calculated based on the travel specification associated with the user,
ranks the plurality of results based on the user-specific values, and
generates a display of information related to the highest-ranked result.

2. The method of claim 1, further comprising generating a note for insertion into the calendar associated with the user, wherein selection of the inserted note results in the display of information related to the highest-ranked result.

3. The method of claim 1, further comprising:
receiving an indication that the user is interested in a plurality of destinations; and
sorting the plurality of results by destination, wherein a subset of the results is identified as being associated with each destination and wherein ranking the plurality of results comprises identifying a highest-ranked result for each subset.

4. The method of claim 1, wherein the user has booked a plurality of trips and further comprising:
storing information regarding the booked trips, and
adjusting an algorithm used to calculate user-specific values, the adjustment based on the stored information regarding the booked trips.

5. The method of claim 4, further comprising:
evaluating the stored information regarding the plurality of booked trips;
identifying one or more common characteristics in the plurality of booked trips; and
generating an updated travel specification based on the identified common characteristics, wherein future searches for the user are based on the updated travel specification.

6. The method of claim 5, further comprising generating a recommendation for a new travel destination, the recommendation based on the identified common characteristics in the plurality of booked trips.

7. The method of claim 1, further comprising receiving information regarding a designated calendar from the user, the designated calendar being uploaded into memory, wherein identifying the one or more consecutive days includes filtering out entries on the designated calendar.

8. A system for user-specific presentation of travel data, the system comprising
a memory for storing information regarding a calendar and a travel specification associated with a user; and
a processor for executing instructions stored in memory, wherein execution of the instructions by the processor:
identifies that one or more consecutive days on the calendar associated with the user are available for travel,
searches a travel database to retrieve a plurality of results available on the identified days,
calculates a user-specific value for each result, the user-specific value being calculated based on the travel specification associated with the user,
ranks the plurality of results based on the user-specific values, and
generates a note for insertion into the calendar associated with the user, wherein selection of the note results in a display of information related to the highest-ranked result.

9. The system of claim 8, wherein further execution of the instructions by the processor generates a note for insertion into the calendar associated with the user, wherein selection of the inserted note results in the display of information related to the highest-ranked result.

10. The system of claim 8, wherein the interface receives an indication that the user is interested in a plurality of destinations and wherein further execution of instructions by the processor sorts the plurality of results by destination, wherein a subset of the results is identified as being associated with each destination and wherein ranking the plurality of results comprises identifying a highest-ranked result for each subset.

11. The system of claim 8, wherein the memory stores information regarding a plurality of trips booked by the user and wherein an algorithm used to calculate user-specific values is adjusted based on the stored information regarding the booked trips.

12. The system of claim 11, wherein further execution of instructions by the processor:
evaluates the stored information regarding the plurality of booked trips;
identifies one or more common characteristics in the plurality of booked trips; and
generates an updated travel specification based on the identified common characteristics, wherein future searches for the user are based on the updated travel specification.

13. The system of claim 12, wherein further execution of instructions by the processor generates a recommendation for a new travel destination, the recommendation based on the identified common characteristics in the plurality of booked trips.

14. The system of claim 8, further comprising an interface for receiving information regarding a designated calendar from the user, the designated calendar being uploaded into memory, wherein identifying the one or more consecutive days includes filtering out entries on the designated calendar.

15. A non-transitory computer-readable storage medium, having embodied thereon a program being executable by a processor to perform a method for user-specific presentation of travel data, the method comprising
storing information received from a user, the information regarding a calendar and a travel specification associated with the user;
identifying that one or more consecutive days on the calendar associated with the user are available for travel;
searching a travel database to retrieve a plurality of results available on the identified days;
calculating a user-specific value for each result, the user-specific value being calculated based on the travel specification associated with the user;
ranking the plurality of results based on the user-specific values; and
generating a display of information related to the highest-ranked result.

16. The non-transitory computer-readable storage medium of claim 15, further comprising executable instructions for generating a note for insertion into the calendar associated with the user, wherein selection of the inserted note results in the display of information related to the highest-ranked result.

17. The non-transitory computer-readable storage medium of claim 15, further comprising executable instructions for:
receiving an indication that the user is interested in a plurality of destinations; and
sorting the plurality of results by destination, wherein a subset of the results is identified as being associated with each destination and wherein ranking the plurality of results comprises identifying a highest-ranked result for each subset.

18. The non-transitory computer-readable storage medium of claim 15, wherein the user has booked a plurality of trips and further comprising executable instructions for:
storing information regarding the booked trips, and
adjusting an algorithm used to calculate user-specific values, the adjustment based on the stored information regarding the booked trips.

19. The non-transitory computer-readable storage medium of claim 18, further comprising executable instructions for:
evaluating the stored information regarding the plurality of booked trips;
identifying one or more common characteristics in the plurality of booked trips; and
generating an updated travel specification based on the identified common characteristics, wherein future searches for the user are based on the updated travel specification.

20. The non-transitory computer-readable storage medium of claim 19, further comprising executable instructions for generating a recommendation for a new travel destination, the recommendation based on the identified common characteristics in the plurality of booked trips.

21. The non-transitory computer-readable storage medium of claim 15, further comprising executable instructions for receiving information regarding a designated calendar from the user, the designated calendar being uploaded into memory, wherein identifying the one or more consecutive days includes filtering out entries on the designated calendar.
